(19) United States
(12) Patent Application Publication
(10) Pub. No.: US 2008/0239882 A1
(43) Pub. Date: Oct. 2, 2008

(54) SIGNALING TIMEPIECE

(76) Inventor: Mark T. Fujii, San Mateo, CA (US)

Correspondence Address: WEST & ASSOCIATES, A PC, 2815 MITCHELL DRIVE, SUITE 209, WALNUT CREEK, CA, 94598, US

(21) Appl. No.: 11/691,898

(22) Filed: Mar. 27, 2007

(51) Int. Cl. G04F 3/06

(52) U.S. Cl. 368/109

(57) ABSTRACT

A novel timepiece that uses color and/or shape and/or symbols to provide a toddler, child or other individual who hasn't learned to tell time or the concept of time to determine if a specified time or time period has been reached. The timepiece can illuminate and/or display a color and/or symbol and/or shape upon reaching a specified time or after an elapsed period of time.

### BACKGROUND

1. Field of the Invention

The current disclosure relates to clocks and timepieces in general used for indicating to children how to tell and/or judge time.

2. Background

Parents and/or caregivers need a way to provide structure to children's routines without the need for constant direct supervision. However, the time frames for when they should be doing a planned activity can be difficult for younger children to understand, especially children that haven't yet learned how to tell time.

Teaching children how to tell time with clocks can be a long and involved process requiring patience and planning. First, the concept of time and its passage must be taught. Then, the children must be taught how to tell time with conventional analog and digital clocks. Teaching children how to read a traditional analog clock requires them to understand how to translate the time on a clock face to hour:minute form. With digital clocks, children must be able to read and order numbers to 60 before they can properly tell time with the clock. There are many devices and methods for teaching children how to tell time known in the prior art. No matter what method and device is used, the process of a child developing time-telling skills needs repetitive drilling and reinforcement, and can take many months for the child to perfect.

Most children learn how to tell time by age five. However, before they can tell time properly, the parents are left with the problem of structuring the child's daily routines without them understanding the “language” of time. It is a common problem, for example, for parents to be woken up before the break of dawn by their children who have no firm understanding of when they should get up.

Traditional alarm clocks with buzzers or radios are commonly available and may be used with children as an alarm for time keeping purposes. However, the noise created by such alarms can be jarring and are potentially frightening for a young child. Furthermore, it doesn't solve the problem of children waking up on their own before they (or their parents) get the required amount of sleep.

Compared to the task of learning how to tell time, children develop the skills of matching, identifying and naming a small number of colors at a much earlier age. Typically, children can tell colors apart by age two. Similarly, children can recognize shapes and simple symbols or drawings much earlier than they learn how to tell time.

What is desired, therefore, is a device that can take advantage of children's early ability to recognize colors and shapes/symbols to bridge the gap before the child learns to tell and/or understand the concept of time.

The device should reinforce the concept of time to the young child and signal to him or her when it is appropriate to perform predetermined activities based on the color and/or shapes and/or symbols shown. It should provide parents with a fun, practical way to provide structure around the concept of time for their child.

Because the child cannot effectively tell and/or judge time, the device can help the parents manage their children by providing structure as they transition through the numerous activities encountered throughout the day that revolve around specific times or time periods.

The device should act as a positive reinforcement and training aid for learning the concept of time and how to tell time using traditional means. It should also be able to help toddlers learn the colors and shapes.

It is further desired that the device be able to reinforce color-coding used in everyday life, such as the use of the color red for “Stop” in traffic lights, and green for “Go”. The device can indicate, by signal, when it is forbidden to do something and/or when an activity is allowed.

It is also desired that the device empower young children through the ability to determine on their own what time period it is.

### SUMMARY

The present disclosure provides a novel timepiece that uses color and/or shapes and/or symbols to provide toddlers and children who haven't learned how to tell time with a non-intrusive way to determine when a specified time or time period has been reached. The timepiece can be illuminated with a chosen color and/or display a symbol/shape upon reaching a specified time or after an elapsed time period. The timepiece can help parents and/or caregivers structure behavior while also introducing the concept of time to their child.

### BRIEF DESCRIPTION OF THE DRAWINGS

FIG. 1, 1a depict a front view of an analog timepiece according to a first embodiment of the invention.

FIG. 2, 2a, 2b, 2c depict front views of digital timepieces according to a second embodiment of the invention.

FIG. 3a, 3b depict front views of wristwatch timepieces according to a third embodiment of the invention.

FIG. 4, 4a-4f depict an embodiment of the timepiece that uses color LEDs to display different shapes and colors.

### DETAILED DESCRIPTION

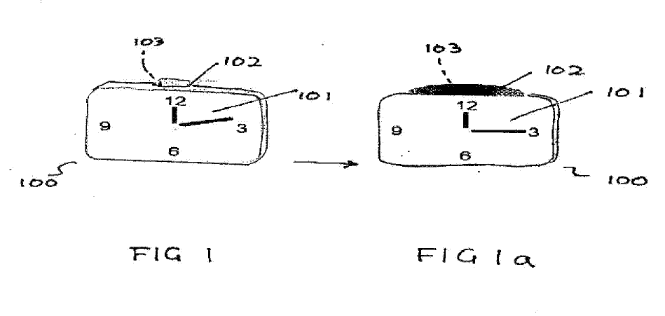

FIG. 1 depicts a front planar view of one embodiment of the novel children's timepiece 100. In this embodiment, it is integral with an analog clock 101. In all of the embodiments discussed in this disclosure, the primary purpose of the traditional clock (analog, digital) is to assist the caregiver in setting the time and/or alarm, since the child user would not know how to correctly read the clock yet or understand the concept of time. A secondary purpose for the traditional clock is as a learning aid for the child to begin learning how to read a traditional clock.

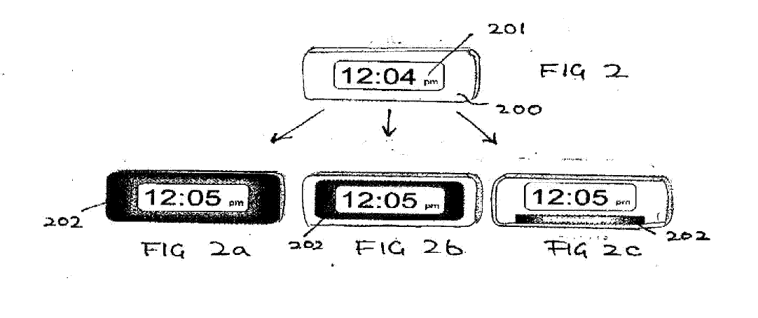

The timepiece 100 has an illumination display 102 that is easily viewable. In the embodiment shown in FIG. 1, the illumination display 102 is situated on top of the timepiece. In further embodiments, the illumination display can be situated on the side, or around the traditional clock (see, for example FIG. 2), or anywhere where it is convenient and easy to view.

The illumination display 102 is lit by at least one internal light source 103 that can light the illumination display 102 in at least one chosen color. In a preferred embodiment of the timepiece, the illumination source can display two or more colors. The internal light source 103 can be chosen from a variety of types, including light bulbs, LEDs, bi-color LEDs, tri-color LEDs or any other source known or convenient that can display a color light. In a further embodiment of the timepiece, a mechanical color filter can be positioned to change the color of the light passing through the filter.

In a preferred embodiment, the novel timepiece has controls, much like a regular alarm clock, that set an “alarm” time. At the set time, the timepiece “goes off” silently by changing the illumination state of the illumination display 102. See FIG. 1a, which depicts a change in the state of the illumination display 102. The state change can, for example, go from unlit to lit, or from a red color to a green color and vice-versa. The change in illumination state signals to the child that a timed condition has been met. For example, a red illumination can mean he is required to stay in bed or his room. When the illumination changes to green, he is allowed to leave the room. The caretaker will teach the child what the colors designate before hand. Simple directions should be used so that the child can easily remember them. “Red” for “Stop” and “stay in your room”, and “Green” for “Go” and “you can come out” would work well. The use of “Red” and “Green” also reinforces in the child color coding conventions used in everyday life, such as for traffic signals. The use of “Red” and “Green” are meant as examples only and is not limiting on the disclosure. Any color combination that can be easily recognized by a child can be used.

Once the child remembers the simple directions and follows the directives consistently, further directions can be given. If the timepiece has the capability to display a third color at a preset time, a third directive can be given. For example, showing the color “Yellow” can mean “Nap time”, “Play time” or any other pre-chosen activity the adult wants the child to perform during a time period.

FIG. 2 depicts a second embodiment of the timepiece 200 utilizing a digital clock 201. Different arrangements of the illumination display 202 are shown in FIG. 2a, 2b and 2c. As in the embodiment discussed above, the traditional clock 201 (here, a digital one) is used primarily for the caregiver to tell time and to set the alarm and secondary for a learning aid for the child.

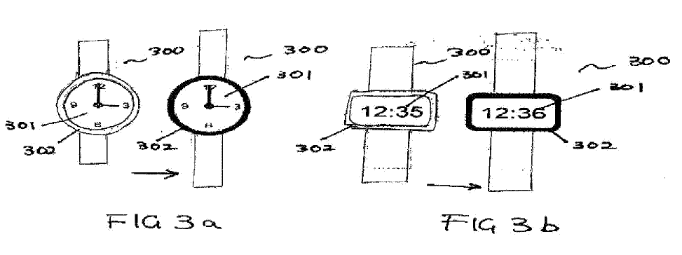

Similarly, FIG. 3a, 3b show further embodiments of the timepiece as wristwatches. FIG. 3a shows a timepiece with a round face and FIG. 3b shows a timepiece with a square face. In both embodiments, the illumination display 302 is a ring on the perimeter of the watch display 301. In further embodiments, the illumination display may be made integral with the watch display. These embodiments may be used as a child's watch and a portable reinforcement for learning to read a traditional timepiece and understanding the concept of time. Even for users than can tell time, a color alarm is eye-catching and may be useful in situations that require silent alerts.

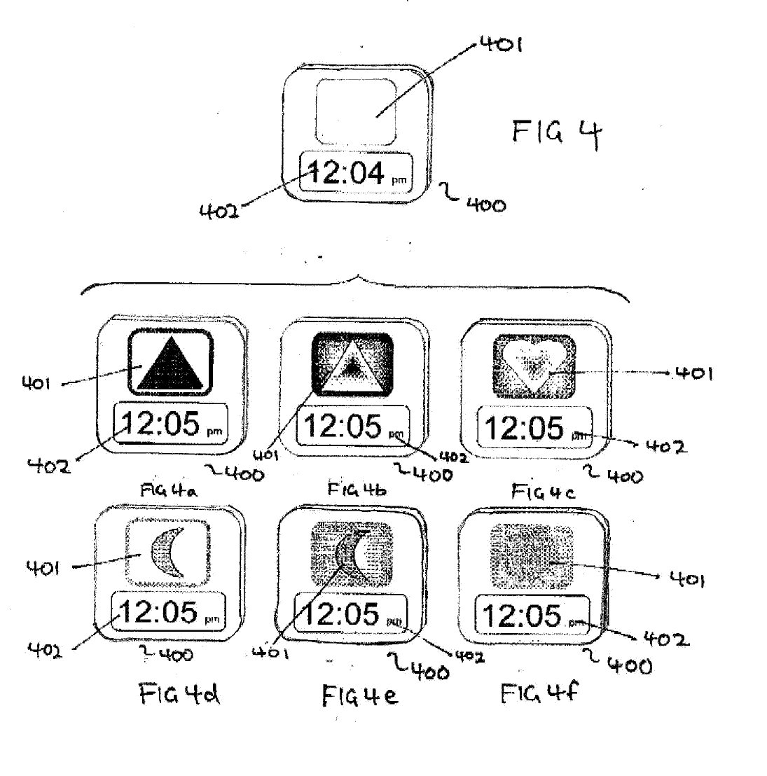

FIG. 4 depicts a further embodiment of the timepiece 400 utilizing a display of multiple light sources 401 in a pattern to depict colors and symbols. An optional digital display 402 can be included for easy setting of the time and alarm. In a preferred embodiment, LEDs, Bi-Colored LEDs or Tri-Colored LEDs can be used. Examples of the light source displaying different symbols in different colors are shown in FIGS. 4a-4f. In FIG. 4f, the light sources are lit in a pattern to depict the sun. In FIG. 4d and 4e, the light sources are lit in a pattern to depict the moon. FIGS. 4a-4f are meant as examples only and are not limiting on the disclosure. In other embodiments of the novel timepiece, any symbol that is easily recognized by a child can be used. In further embodiments, the symbol depicted and colors used may be chosen by the adult end-user.

The novel timepiece can be designed to provide parents with a fun, practical way to provide structure around the concept of time for their kids. A secondary focus can be for a child to being to learn how to tell time by using the timepiece on a daily basis for their daily routines. The idea is to provide children and toddlers with a way to help them understand when a specific time has been reached or elapsed, even when they cannot read a traditional clock. However, the novel timepiece shouldn't be used to strictly keep children relegated to a room when the time conditions haven't been met. Children should always understand that they are free to contact the parents, irrespective of the color or lack thereof, in the event of an emergency. The definition of an emergency should be discussed between the parents and the children.

The timepiece can have further applications even for adults or older children that can tell time. The illumination display can act as a night light, and a quick glance at the color can alert the user as to what general time it is without having to read the clock. This is helpful for those that may have to put on glasses to read a clock. Multiple shades of color can be employed if it is desired for the timepiece to have the capability to display detailed time information without the use of traditional digital or analog means.

While the device has primarily described as being used in connection with children, it can be used with any person and/or population in which it is desirable to teach, reinforce and/or indicate the concept of time and/or temporal relationships.

Although the invention has been described in conjunction with specific embodiments thereof, it is evident that many alternatives, modifications and variations will be apparent to those skilled in the art. Accordingly, the apparatus as described and hereinafter claimed is intended to embrace all such alternatives, modifications and variations that fall within the spirit and broad scope of the appended claims.

1. a timepiece comprising:
at least one illumination source;
an illumination display lit by said at least one illumination source;
timing means to time a predetermined period;
means to set at least one of a time and a time period within said predetermined period;
a power supply to supply power to said at least one illumination source and said timing means; and
a mechanical color filter positioned to selectively change the visible spectrum of the emitted light;
wherein said illumination source changes its illumination state upon said timing means reaching one of said set time and a boundary of said time period.

2. The timepiece of claim 1, wherein said illumination source changes its illumination state from a first color.

3. The timepiece of claim 1, wherein said illumination source changes its illumination state from a first state.

4. The timepiece of claim 1, further comprising display means to display the time designated by said timing means.

5. The timepiece of claim 4, wherein said display means is an analog clock.

6. The timepiece of claim 4, wherein said display means is a digital clock.

7. The timepiece of claim 1, wherein the timepiece is in the form of a wristwatch.

8. A timepiece to depict time information comprising:
a plurality of illumination sources;
a mechanical color filter positioned to selectively change the visible spectrum of the emitted light;
timing means to time a predetermined period;
means to set one of a time and a time period within said predetermined period;
a power supply to supply power to said plurality of illumination sources and said timing means;
said plurality of illumination sources arranged in a display that depict a symbol in a first illumination state; and
said plurality illumination sources changes their illumination state to depict a different symbol upon said timing means reaching one of said set time and a boundary of said time period.

9. The timepiece of claim 7, wherein said first illumination state and second illumination state are different in color.

10. A timepiece comprising:
a display;
said display capable of displaying at least two different graphics;
timing means to time a time period;
at least one illumination source used to illuminate a selected graphic; and
a mechanical color filter positioned to selectively change the visible spectrum of the emitted light;
wherein said display changes from displaying a first graphic to displaying a second graphic at the end of said time period.

11. The timepiece of claim 10, wherein said display changes from a first graphic to a second graphic by mechanical means.

12. A timepiece comprising:
at least one illumination source;
an illumination display lit by said at least one illumination source; timing means to time a time period;
a power supply to supply power to said at least one illumination source and said timing means;
a mechanical color filter positioned to selectively change the visible spectrum of the emitted light;
wherein said illumination source changes its illumination state at the boundary of said time period.

13. The timepiece of claim 12, wherein said illumination source changes its illumination state from a first color.

14. The timepiece of claim 12, wherein said illumination source changes its illumination state from a first state.

15. The timepiece of claim 12, further comprising a display means to display the time designated by said timing means.

16. The timepiece of claim 15, wherein said display means is an analog timer.

17. The timepiece of claim 15, wherein said display means is a digital timer.
